(19) United States
(12) Patent Application Publication
(10) Pub. No.: US 2015/0211463 A1
(43) Pub. Date: Jul. 30, 2015

(54) DIESEL ENGINE

(71) Applicant: IHI Shibaura Machinery Corporation, Matsumoto-shi, Nagano (JP)

(72) Inventors: Naohiro Hasegawa, Matsumoto-shi (JP); Naotsugu Kanai, Matsumoto-shi (JP); Seigo Tanimoto, Matsumoto-shi (JP); Yuichi Kawaai, Matsumoto-shi (JP); Yutaka Mashima, Matsumoto-shi (JP)

(73) Assignee: IHI Shibaura Machinery Corporation, Matsumoto-shi, Nagano (JP)

(21) Appl. No.: 14/416,550

(22) PCT Filed: Jul. 22, 2013
(86) PCT No.: PCT/JP2013/069810

§ 371 Date: Jan. 22, 2015

(30) Foreign Application Priority Data
Jul. 24, 2012 (JP) 2012-164219

(51) Int. Cl. F02M 63/02

(52) U.S. Cl. CPC F02M 63/0275; F02M 63/0265

(57) ABSTRACT

This diesel engine is provided with pistons which slide, moving to and from the cylinder head, and which converts the sliding motion of the pistons into rotational motion of a crankshaft. This diesel engine is further provided with a supply pump which is driven by rotation of the crankshaft, a rail which stores fuel pumped from the supply pump, and injectors which inject the fuel supplied from the rail into the combustion chambers formed in the pistons, wherein the rail and the injectors are fixed to the cylinder head.

### BACKGROUND OF THE INVENTION

1. Technical Field

The present invention relates to an art of a diesel engine.

2. Background Art

Conventionally, a diesel engine, in which fuel is injected to a combustion chamber provided in an upper surface of a piston and the fuel is burnt in the combustion chamber, is known. Such a diesel engine has a pressure accumulating fuel injector whose injection pattern can be set freely (hereinafter, referred to as “common rail system”). The common rail system includes a supply pump pressingly feeding the fuel, a rail storing the fuel with high pressure, and an injector injecting the fuel (for example, see the Patent Literature 1).

Such a diesel engine has a metal pipe for supplying the fuel stored in the rail with high pressure to the injector (hereinafter, referred to as “injection pipe”). Namely, the rail is connected to the injector by the injection pipe. However, the injection pipe must bear the fuel with high pressure, whereby the injection pipe has high hardness and poor flexibility. Accordingly, a structure which prevents breakage of the injection pipe and looseness of attachment nuts of the injection pipe resulting from vibration and the like has been required.

In such a diesel engine, operation state is changed corresponding to temperature of the fuel supplied to the injector. That is because a calorific value per unit volume of the fuel is reduced when the fuel is heated and expands and the calorific value per unit volume of the fuel is increased when the fuel is cooled and contracts. Especially, at the time of starting the engine in the cold district, there is a problem in that it takes time for the temperature of the fuel to reach a suitable value because the rail and the injection pipe are cooled. Accordingly, a structure in which the fuel temperature can be set quickly to the suitable value at the time of starting the engine in the cold district has been required.

### PRIOR ART REFERENCE PATENT LITERATURE

Patent Literature 1: the Japanese Patent Laid Open Gazette 2011-12573

### BRIEF SUMMARY OF THE INVENTION

### Problems to Be Solved by the Invention

The purpose of the present invention is to provide a diesel engine which prevents breakage of an injection pipe and looseness of attachment nuts of an injection pipe resulting from vibration and the like. Furthermore, the purpose of the present invention is to provide a diesel engine in which fuel temperature can be set quickly to a suitable value at the time of starting the engine in the cold district.

### Means for Solving the Problems

A diesel engine according to the first mode of the present invention, which has a piston slid toward or oppositely to a cylinder head and converts sliding motion of the piston into rotational motion of a crankshaft, comprises a supply pump driven by the rotation of the crankshaft, a rail storing fuel fed pressingly from the supply pump, and an injector injecting the fuel supplied from the rail to a combustion chamber formed in the piston. The rail and the injector are fixed to the cylinder head.

A diesel engine according to the second mode of the present invention is the diesel engine according to the first mode of the present invention, wherein the cylinder head has a substantially rectangular parallelepiped shape, the rail is formed substantially cylindrically, and the rail is fixed while an axis of the rail is in parallel to a lengthwise direction of the cylinder head.

A diesel engine according to the third mode of the present invention is the diesel engine according to the first or second mode of the present invention, wherein the rail is supported by a bracket provided at a low position in a height direction of the cylinder head.

### Effect of the Invention

The present invention configured as the above brings the following effects.

According to the first mode, the rail and the injector are fixed to the cylinder head.

Accordingly, a vibration source of the rail 4 and a vibration source of the injector are the cylinder head, whereby breakage of the injection pipe and looseness of attachment nuts of the injection pipe can be prevented.

According to the second mode, the rail is fixed while the axis of the rail is in parallel to the lengthwise direction of the cylinder head. Accordingly, any bending stress is not generated on the rail even if the cylinder head is heat-expanded, whereby the breakage of the injection pipe and the looseness of the attachment nuts of the injection pipe can be prevented.

According to the third mode, the rail is supported by the bracket provided at the low position in the height direction of the cylinder head. Accordingly, the heat is transmitted suitably from the cylinder head to the rail, whereby the fuel temperature can be set to the suitable value quickly at the time of starting the engine in the cold district.

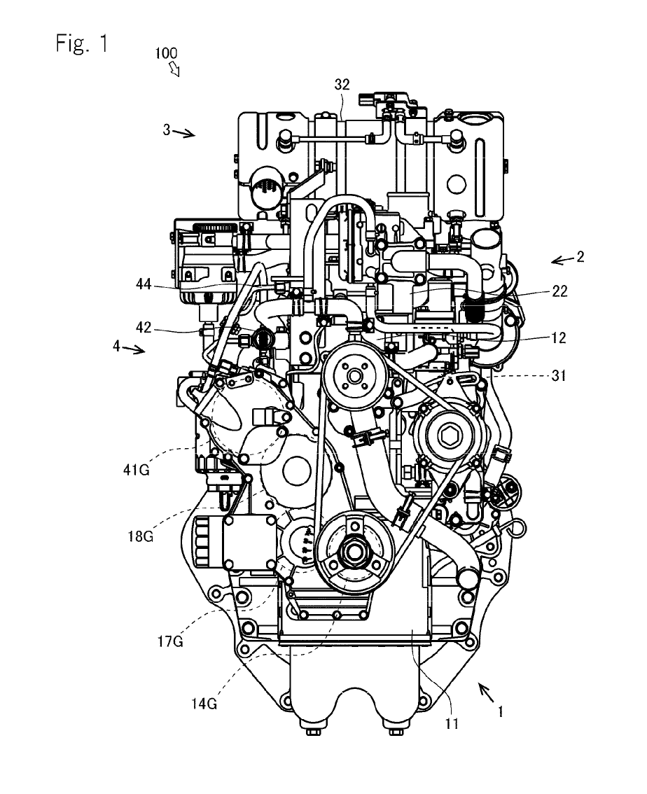

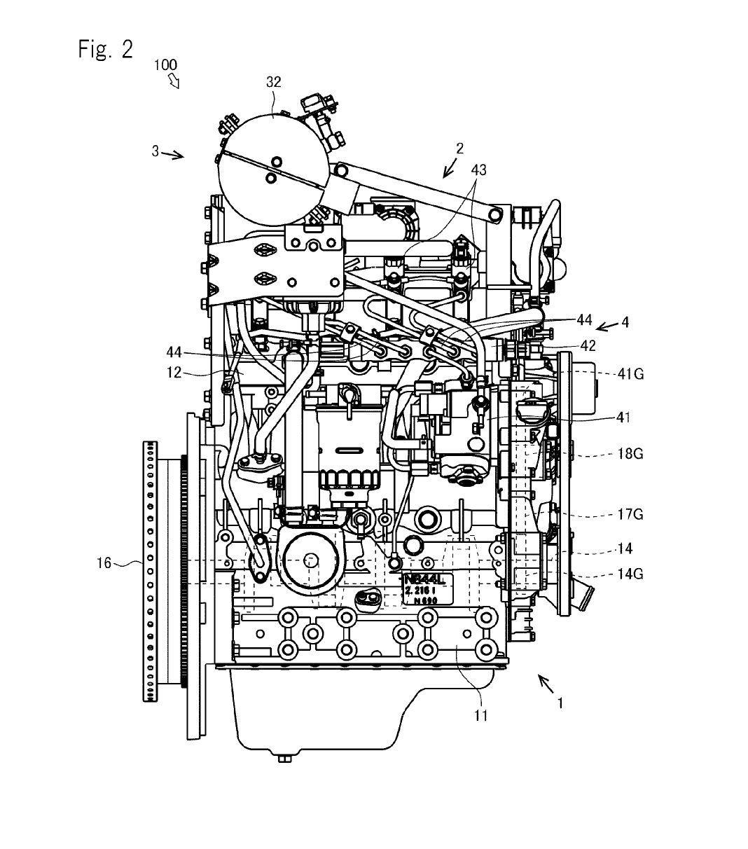

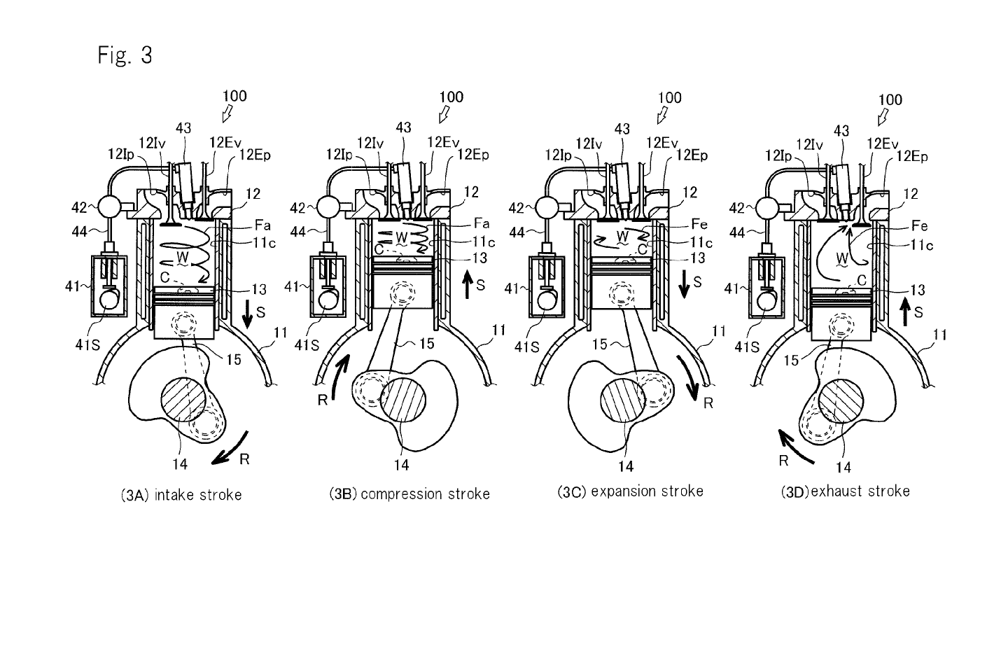

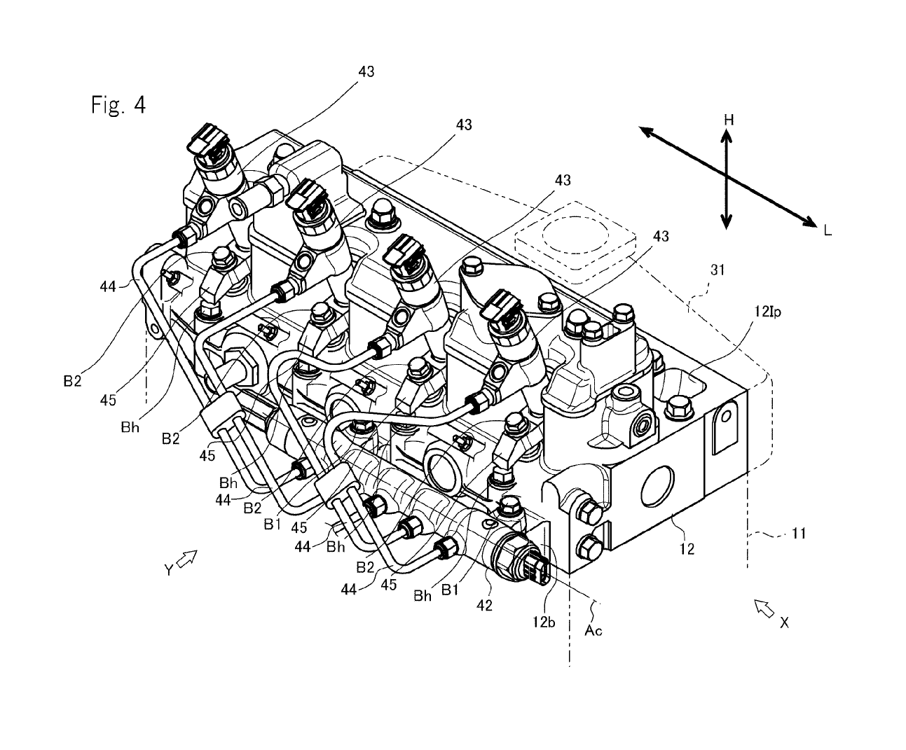

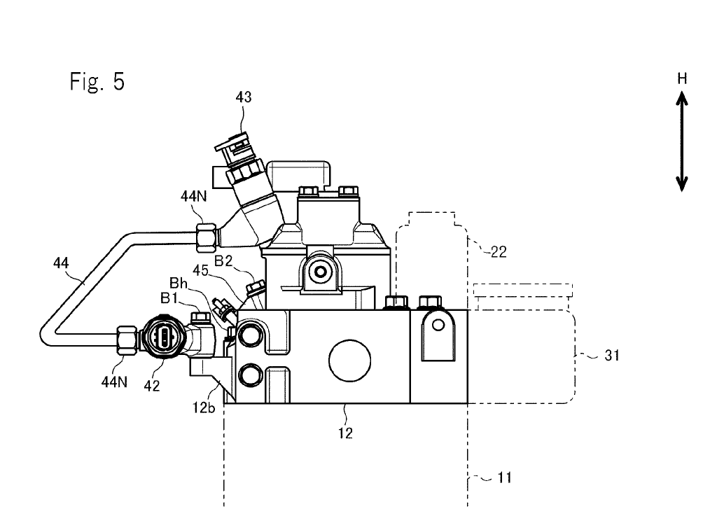

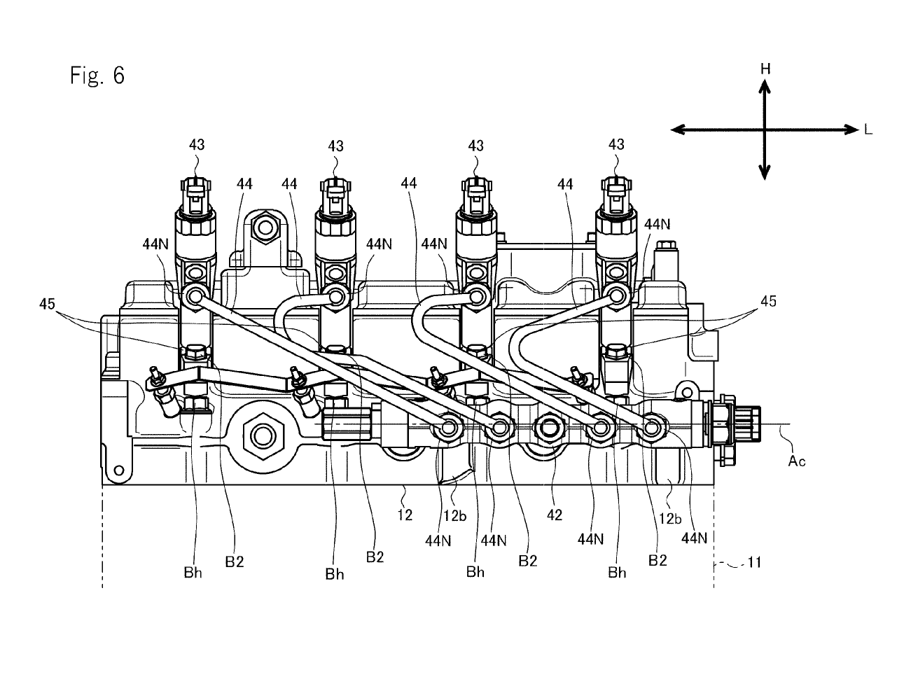

### BRIEF DESCRIPTION OF THE DRAWINGS

[FIG. 1] FIG. 1 is a front view of a diesel engine.

[FIG. 2] FIG. 2 is a right side view of the diesel engine.

[FIG. 3] FIG. 3 is a schematic drawing of an operation mode of the diesel engine.

[FIG. 4] FIG. 4 is a perspective view of the state in which a rail and an injector are attached to a cylinder head.

[FIG. 5] FIG. 5 is a drawing viewed from a direction of an arrow X in FIG. 4.

[FIG. 6] FIG. 6 is a drawing viewed from a direction of an arrow Y in FIG. 4.

### DETAILED DESCRIPTION OF THE INVENTION

Next, an explanation will be given on a mode for carrying out the invention.

Firstly, an explanation will be given on a diesel engine 100 briefly.

FIG. 1 is a front view of the diesel engine 100, and FIG. 2 is a right side view thereof. FIG. 3 is a schematic drawing of an operation mode of the diesel engine 100. Arrows Fa in the drawing show flow direction of sucked air, and arrows Fe in the drawing show flow direction of exhaust gas. Arrows S in the drawing show sliding direction of a piston 13, and arrows R in the drawing show rotation direction of a crankshaft 14.

The diesel engine 100 mainly includes an engine main part 1, an intake path 2, an exhaust path 3 and a common rail system 4.

The engine main part 1 generates rotation power by using expansion energy of combustion of fuel. The engine main part 1 mainly includes a cylinder block 11, a cylinder head 12, the piston 13 and the crankshaft 14.

In the engine main part 1, a cylinder 11c provided in the cylinder block 11, the piston 13 provided slidably inside the cylinder 11c, and the cylinder head 12 arranged oppositely to the piston 13 constitute an operation chamber W. Namely, the operation chamber W means an inner space of the cylinder 11 c whose capacity is changed by sliding movement of the piston 13. The piston 13 is connected via a connecting rod 15 to a pin part of the crankshaft 14 so that the crankshaft 14 is rotated by the slide of the piston 13. A concrete operation mode of the engine main part 1 is discussed later.

The intake path 2 guides air sucked from the outside into the cylinder 11c.

Namely, the intake path 2 guides the air sucked from the outside into the operation chamber W. The intake path 2 mainly includes an air cleaner (not shown) and an intake manifold 22 along a flow direction of the air.

The air cleaner filters the sucked air with a filter paper, sponge or the like. The air cleaner filters the air so as to prevent foreign matters such as dust from entering the operation chamber W.

The intake manifold 22 distributes the air filtered by the air cleaner to the operation chambers W. Since the diesel engine 100 is a multiple cylinder engine in which the plurality of the operation chambers W are provided, the intake manifold 22 is provided so as to cover an inlet port of an intake port 12Ip provided in each of the operation chambers W. In the diesel engine 100, since the inlet port of the intake port 12Ip is provided in an upper surface of the cylinder head 12, the intake manifold 22 is attached to the upper surface of the cylinder head 12.

The exhaust path 3 guides exhaust gas discharged from an inside of the cylinder 11 c to an exhaust port. Namely, the exhaust path 3 guides the exhaust gas discharged from the operation chambers W to the exhaust port. The exhaust path 3 mainly includes an exhaust manifold 31 and an exhaust purification device 32 along a flow direction of the exhaust gas.

The exhaust manifold 31 gathers exhaust gas discharged respectively from the operation chambers W. Since the diesel engine 100 is the multiple cylinder engine in which the plurality of the operation chambers W are provided, the exhaust manifold 31 is communicated with an outlet hole of an exhaust port 12Ep provided in each of the operation chambers W. In the diesel engine 100, since an outlet hole of the exhaust port 12Ep is provided in a side surface of the cylinder head 12, the exhaust manifold 31 is attached to the side surface of the cylinder head 12.

The exhaust purification device 32 removes environmental load substances contained in the exhaust gas. A diesel oxidation catalyst (hereinafter, referred to as “DOC”) is provided in the exhaust purification device 32. The DOC oxidizes and detoxifies CO (carbon monoxide) and HC (hydrocarbon), and oxidizes and removes SOFs (soluble organic fractions) which are particle matters.

The common rail system 4 is a fuel injection device whose injection pattern can be set freely. The common rail system 4 mainly includes a supply pump 41, a rail 42 and injectors 43.

The supply pump 41 feeds pressingly fuel discharged from a fuel tank to the rail 42. The supply pump 41 is driven by rotation power of the crankshaft 14 transmitted via a plurality of gears. In detail, the supply pump 41 is driven by the rotation power of the crankshaft 14 transmitted via a crank gear 14G, an idle gear 17G, a cam gear 18G and a pump gear 41G. The supply pump 41 has a plunger slid by rotation of a driving shaft 41S, and the fuel pressurized by the plunger is sent to the rail 42.

The rail 42 stores the fuel, which is fed pressingly from the supply pump 41, at high pressure. The rail 42 is a metal pipe shaped substantially cylindrically. The rail 42 has a limiter valve and is designed so as to prevent pressure of the fuel from exceeding a predetermined value. A plurality of injection pipes 44 are attached to the rail 42 so as to guide the fuel to the injectors 43.

The injectors 43 inject suitably the fuel supplied from the rail 42. Each of the injectors 43 is attached to the corresponding cylinder head 12 so that a tip of the injector 43 having an injection port is projected into the operation chamber W. The injector 43 has an armature driven by a piezo element or a solenoid for example, and can realize various injection patterns by controlling timing and term of the driving.

Next, an explanation will be given on an operation mode of the diesel engine 100 in brief referring to FIG. 3. The diesel engine 100 is a 4-cycle engine in which an intake stroke, a compression stroke, an expansion stroke and an exhaust stroke are completed while the crankshaft 14 is rotated two times.

In the intake stroke, an intake valve 12Iv is opened and the piston 13 is slid downward (oppositely to the cylinder head 12) so as to suck air into the operation chamber W. As the above, in the diesel engine 100, since the inlet port of the intake port 12Ip is provided in the upper surface of the cylinder head 12, the air flows from an upper side to a lower side of the cylinder head 12.

In the compression stroke, the intake valve 12Iv is closed and the piston 13 is slid upward (toward the cylinder head 12) so as to compress the air in the operation chamber W. Since the intake port 12Ip is closed by the intake valve 12Iv, the air in the operation chamber W does not flow reversely.

Subsequently, the fuel is injected from the injector 43 to the air whose temperature and pressure are increased by the compression. Then, the fuel is dispersed and evaporated in a combustion chamber C provided in an upper surface of the piston 13, and mixed with the air and burnt. Accordingly, the diesel engine 100 shifts to the expansion stroke in which the piston 13 is slid downward again.

In the expansion stroke, the piston 13 is pushed downward (oppositely to the cylinder head 12) with expansion energy generated by combustion of fuel. Flame formed in the combustion chamber C and the operation chamber W expands air so as to push down the piston 13. In the expansion stroke, rotation torque is applied from the piston 13 via the connecting rod 15 to the crankshaft 14. At this time, since kinetic energy is conserved by a flywheel 16 attached to the crankshaft 14, the rotation of the crankshaft 14 is maintained (see FIG. 2). Accordingly, the diesel engine 100 shifts to the exhaust stroke.

In the exhaust stroke, an exhaust valve 12Ev is opened and the piston 13 is slid upward (toward the cylinder head 12) so as to push out the burnt gas in the operation chamber W as the exhaust gas. As the above, in the diesel engine 100, since the outlet hole of the exhaust port 12Ep is provided in the side surface of the cylinder head 12, the exhaust gas flows sideways from the lower side of the cylinder head 12.

Accordingly, the diesel engine 100 completes the intake stroke, the compression stroke, the expansion stroke and the exhaust stroke while the crankshaft 14 is rotated two times. By continuing the strokes in all the operation chambers W, the diesel engine 100 can be driven continuously.

An explanation will be given on a structure of the diesel engine 100 in detail, and effect of the structure will be described.

FIG. 4 is a perspective view of the state in which the rail 42 and the injector 43 are attached to the cylinder head 12. FIG. 5 is a drawing viewed from a direction of an arrow X in FIG. 4, and FIG. 6 is a drawing viewed from a direction of an arrow Y in FIG. 4.

The rail 42 is fixed to a bracket 12b, provided in a side surface of the cylinder head 12, with a bolt B1. The bracket 12b is provided in not the side surface to which the exhaust manifold 31 is attached but the side surface opposite thereto. As the above, in the diesel engine 100, since the intake manifold 22 is attached to the upper surface of the cylinder head 12 (see FIGS. 1 and 2), the bracket 12b can be provided in the side surface to which the exhaust manifold 31 is not attached.

The injector 43 is fixed by a holder 45 while being inserted into an injector hole of the cylinder head 12. The holder 45 is fixed with a bolt B2 while a hanging part of the holder 45 pinches a body of the injector 43 and a fulcrum part of the holder 45 contacts a head bolt Bh. Since the bolt B2 is attached via a spherical washer, an attachment posture of the injector 43 is stable.

Accordingly, the rail 42 and the injector 43 are fixed to the cylinder head 12.

Then, vibration generated by operation of the diesel engine 100 is transmitted to the rail 42 and the injector 43 substantially equally. The injection pipe 44 connecting the rail 42 to the injector 43 is vibrated integrally with them.

For these reasons, in the diesel engine 100, since a vibration source of the rail 42 and a vibration source of the injector 43 are the cylinder head 12, breakage of the injection pipe 44 and looseness of attachment nuts 44N of the injection pipe 44 can be prevented.

In the configuration in which the intake manifold 22 is attached to the upper surface of the cylinder head 12 like the diesel engine 100, it is important to fix the rail 42 to not the side surface to which the exhaust manifold 31 is attached but the side surface opposite thereto. That is because any part is not heated so that safety is improved and the structure supporting the rail 42 is simplified. This space which is easy to become a dead space can be used effectively.

Next, an attachment posture of the rail 42 is limited.

Generally, the cylinder head 12 has a substantially rectangular parallelepiped shape. Then, when the cylinder head 12 is heated by the operation of the diesel engine 100, the cylinder head 12 is expanded greatly along a lengthwise direction L. On the other hand, the rail 42 is shaped substantially cylindrically. In the diesel engine 100, the bracket 12b is provided so as to make an axis Ac of the rail 42 and the lengthwise direction L of the cylinder head 12 in parallel to each other.

Accordingly, the rail 42 is fixed while the axis Ac thereof is in parallel to the lengthwise direction L of the cylinder head 12. Then, load applied to the rail 42 by thermal expansion of the cylinder head 12 acts along the axis Ac of the rail 42.

For these reasons, in the diesel engine 100, since any bending stress is not generated on the rail 42 even if the cylinder head 12 is heat-expanded, the breakage of the injection pipe 44 and the looseness of the attachment nuts 44N of the injection pipe 44 can be prevented.

In the diesel engine 100, the bracket 12b is provided at a low position in a height direction H of the cylinder head 12. That is because of the consideration for enabling fuel temperature to be set to a suitable value quickly at the time of starting the engine in the cold district.

Accordingly, the rail 42 is supported by the bracket 12b provided at the low position in the height direction H of the cylinder head 12. Then, heat generated in the operation chamber W can be transmitted quickly to the rail 42 and fuel in the rail 42 can be heated.

For these reasons, in the diesel engine 100, since the heat is transmitted suitably from the cylinder head 12 to the rail 42, the fuel temperature can be set to the suitable value quickly at the time of starting the engine in the cold district.

### INDUSTRIAL APPLICABILITY

The present invention can be used for an art of a diesel engine.

### Description of Notations

100 diesel engine
1 engine main part
11 cylinder block
12 cylinder head
13 piston
14 crankshaft
2 intake path
3 exhaust path
31 exhaust manifold
4 common rail system
41 supply pump
42 rail
43 injector
44 injection pipe
44N attachment nut
45 holder
Ac axis
Bh head bolt
B1 bolt
B2 bolt
L lengthwise direction
H height direction

1. A diesel engine having a piston slid toward or oppositely to a cylinder head and converting sliding motion of the piston into rotational motion of a crankshaft, comprising:
a supply pump driven by the rotation of the crankshaft;
a rail storing fuel fed pressingly from the supply pump; and
an injector injecting the fuel supplied from the rail to a combustion chamber formed in the piston,
characterized in that the rail and the injector are fixed to the cylinder head.

2. The diesel engine according to claim 1,
wherein the cylinder head has a substantially rectangular parallelepiped shape,
wherein the rail is formed substantially cylindrically, and
wherein the rail is fixed while an axis of the rail is in parallel to a lengthwise direction of the cylinder head.

3. The diesel engine according to claim 1,
wherein the rail is supported by a bracket provided at a low position in a height direction of the cylinder head.
